(19) United States
(12) Patent Application Publication
(10) Pub. No.: US 2025/0274872 A1
(43) Pub. Date: Aug. 28, 2025

(54) Devices and Systems for Learning Wi-Fi Access Point Behavior To Reduce Power Consumption

(71) Applicant: Silicon Laboratories Inc., Austin, TX (US)

(72) Inventor: Atul Suresh Joshi, Pune (IN)

(21) Appl. No.: 18/588,482

(22) Filed: Feb. 27, 2024

(51) Int. Cl. H04W 52/02

(52) U.S. Cl. CPC H04W 52/0258; H04W 52/0216

(57) ABSTRACT

Methods and Wi-Fi devices that learn the behavior of an associated access point and modify their actions accordingly are disclosed. The low power Wi-Fi device may begin in a default state and observe the behavior of the access point. Based on this observed behavior, the low power Wi-Fi device may continue operating in the default state, or may modify its actions. Some of the behaviors of the access point that are monitored include its response to PS-Poll packets, its “keep alive” behavior and its use of aggregation. In each case, the low power Wi-Fi device is able to modify its actions if the access point operates in a manner that differs from that expected. As a result of the modifications, the low power Wi-Fi device may reduce its power consumption.

### FIELD

This disclosure describes systems and various methods of learning the behavior of an access point in a Wi-Fi network and adapting the operation of a wireless device based on that learning.

### BACKGROUND

The Wi-Fi protocol was originally designed to include devices which have access to unlimited power. Thus, early revisions of the specification did not include any provisions to support very low power devices, which need to enter low power modes in order to conserve battery life. For example, some devices, such as sensor devices, should ideally have a battery life that is more than one year.

The Wi-Fi protocol was updated to include some power saving modes of operation. For example, one such update is the inclusion of PS-Poll. In this mode, the low power Wi-Fi device notifies the access point that it is entering a sleep mode. The access point will then buffer all outbound messages for this low power Wi-Fi device. If it has any outbound packets for this device, it indicates this in its beacon message using the Traffic Indication Map (TIM) bit for the device. After waking, the low power Wi-Fi device checks the TIM bit in the beacon and if there are stored messages, it transmits a PS-Poll packet to the access point, requesting the stored packets.

According to the specification, the access point then transmits the buffered packets to the low power Wi-Fi device. If there are multiple buffered packets, the access point sets the “more Data” bit in all but the final packet, indicating to the low power Wi-Fi device that there are still more buffered packets to retrieve.

While this feature allows devices in the Wi-Fi network to have a low power mode, there are complications associated with this feature that need to be addressed. For example, certain access points utilize the TIM bit, but do not respond properly to PS-Poll packets.

Another issue is the use of “keep alive” or “heart beat” messages by the access point. Certain access points transmit “keep alive” messages while the low power Wi-Fi device is in sleep mode. Other access points exhibit other behaviors to maintain the TCP connection.

Other anomalies in the behavior of the access point have also been observed. Some of these behaviors may result in increased power consumption of the low power Wi-Fi device.

Therefore, it would be beneficial if there was a system and method by which the low power Wi-Fi device could learn the behavior of the access point and modify its own actions accordingly. These modifications may serve to reduce the power consumption of the low power Wi-Fi device.

### SUMMARY

Methods and Wi-Fi devices that learn the behavior of an associated access point and modify their actions accordingly are disclosed. The low power Wi-Fi device may begin in a learning state and observe the behavior of the access point. Based on this observed behavior, the low power Wi-Fi device may continue operating in a default state, or may modify its actions. Some of the behaviors of the access point that are monitored include its response to PS-Poll packets, its “keep alive” behavior and its use of aggregation. In each case, the low power Wi-Fi device is able to modify its actions if the access point operates in a manner that differs from that expected. As a result of the modifications, the low power Wi-Fi device may reduce its power consumption.

According to one embodiment, a method of operating a low power Wi-Fi device is disclosed. The method comprises observing a behavior of an access point while the low power Wi-Fi device is in a default operation state; and if the behavior differs from an expected behavior, modifying an operation of the low power Wi-Fi device to reduce transmissions or power consumption. In some embodiments, the low power Wi-Fi device observes a response of the access point to PS-Poll messages. In certain embodiments, if the access point does not respond to PS-Poll messages, the low power Wi-Fi device modifies the operation by transmitting packets with a power management (PM) bit set to 0 or 1 to indicate when the low power Wi-Fi device is in an active mode and a power saving mode, respectively. In certain embodiments, the packets transmitted with the PM bit set to 0 or 1 are NULL packets, QOS NULL Packets, data packets or QOS data packets. In some embodiments, the low power Wi-Fi device observes a number of “keep alive” messages transmitted by the access point while the low power Wi-Fi device is in a power saving or sleep mode. In certain embodiments, if the number of “keep alive” messages is less than a predetermined threshold, the low power Wi-Fi device utilizes PS-Poll messages. In certain embodiments, if the number of “keep alive” messages is greater than a predetermined threshold, the low power Wi-Fi device modifies the operation by transmitting packets with a power management (PM) bit set to 0 to indicate that the low power Wi-Fi device is in an active mode. In some embodiments, the low power Wi-Fi device observes a number and type of TIDs (traffic identifiers) for which aggregation context is requested by the access point. In certain embodiments, if the low power Wi-Fi device has continuous or bursty data associated with the TIDs, it establishes the aggregation context. In certain embodiments, if the low power Wi-Fi device has occasional data associated with the TIDs, the low power Wi-Fi device modifies the operation by rejecting the request and transmitting packets with a power management (PM) bit set to 0 to indicate that the low power Wi-Fi device is in an active mode. In some embodiments, the method includes exiting a modified operation mode after a predetermined amount of time or a predetermined number of packets, and repeating the observing. In some embodiments, the method includes exiting a modified operation mode if a connection between the low power Wi-Fi device and the access point is terminated and repeating the observing.

According to another embodiment, a low power Wi-Fi device is disclosed. The device comprises a Wi-Fi network interface; a processing unit; and a memory device, in communication with the processing unit, containing instructions, which when executed by the processing unit, enable the low power Wi-Fi device to: observe a behavior of an access point while the low power Wi-Fi device is in a default operation state; and modify an operation of the low power Wi-Fi device if the behavior differs from an expected behavior, in order to reduce transmissions or power consumption. In some embodiments, the low power Wi-Fi device observes a response of the access point to PS-Poll messages. In certain embodiments, the memory device further comprises instructions that enable the low power Wi-Fi device to: modify the operation by transmitting packets with a power management (PM) bit set to 0 or 1 to indicate when the low power Wi-Fi device is in an active mode and a power saving mode, respectively, if the access point does not respond to PS-Poll messages. In some embodiments, the low power Wi-Fi device observes a number of “keep alive” messages transmitted by the access point while the low power Wi-Fi device is in a power saving or sleep mode. In certain embodiments, the memory device further comprises instructions that enable the low power Wi-Fi device to: transmit PS-Poll messages if the number of “keep alive” messages is less than a predetermined threshold; and transmit packets with a power management (PM) bit set to 0 to indicate that the low power Wi-Fi device is in an active mode if the number of “keep alive” messages is equal to or greater than the predetermined threshold. In some embodiments, the low power Wi-Fi device observes a number and type of TIDs (traffic identifiers) for which aggregation context is requested by the access point. In certain embodiments, the memory device further comprises instructions that enable the low power Wi-Fi device to: establish the aggregation context if the low power Wi-Fi device has continuous or bursty data associated with the TIDs; and reject request and transmit packets with a power management (PM) bit set to 0 to indicate that the low power Wi-Fi device is in an active mode if the low power Wi-Fi device has occasional data associated with the TIDs.

### BRIEF DESCRIPTION OF THE DRAWINGS

For a better understanding of the present disclosure, reference is made to the accompanying drawings, in which like elements are referenced with like numerals, and in which:

FIG. 1 shows a block diagram of a Wi-Fi network device;

FIG. 2 shows a system that includes a Wi-Fi network;

FIG. 3 shows a general flowchart highlighting the operation of the low power Wi-Fi device;

FIG. 4 shows a first example of modified operation based on the response to PS-Poll packets;

FIGS. 5A-5B show a second example of modified operation based on the number of “keep alive” packets that are sent; and

FIG. 6 shows a third example of modified operation based on the aggregation context requested by the access point.

### DETAILED DESCRIPTION

This disclosure presents a system and methods of learning the behavior of an access point in a Wi-Fi network and adapting the operation of a device based on that learning.

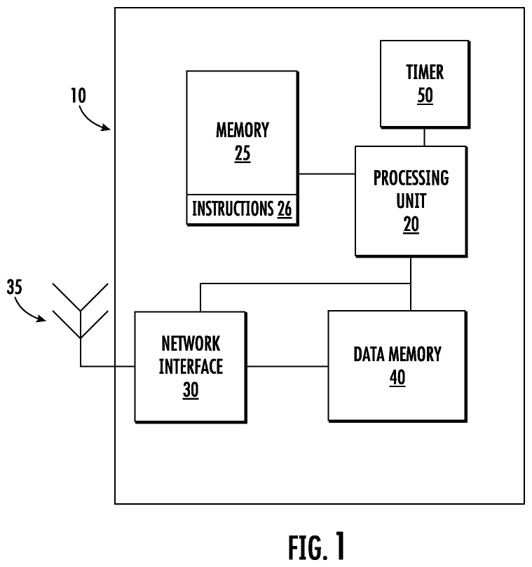

FIG. 1 shows a block diagram of a representative Wi-Fi device 10 that may be used to implement the disclosed method of minimizing power consumption in a Wi-Fi network.

The Wi-Fi device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the Wi-Fi device 10 to perform the functions described herein. This memory device 25 may be a non-volatile memory, such as a FLASH ROM, an electrically erasable ROM or other suitable devices. In other embodiments, the memory device may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CDROM, or a different memory device, which is located remote from the Wi-Fi device 10. The instructions contained on this second computer readable non-transitory media may be downloaded onto the memory device 25 to allow execution of the instructions by the Wi-Fi device 10.

The Wi-Fi device 10 also includes a Wi-Fi network interface 30 that connects with a Wi-Fi network 100 using an antenna 35.

The Wi-Fi device 10 may include a data memory device 40 in which data that is received and transmitted by the Wi-Fi network interface 30 is stored. This data memory device 40 is traditionally a volatile memory. The processing unit 20 has the ability to read and write the data memory device 40 so as to communicate with the other devices in the Wi-Fi network 100.

Additionally, the Wi-Fi device 10 may include a timer 50. The timer 50 may be used to measure time durations. Further, the timer 50 may be used to wake the processing unit 20 from its low power or sleep mode.

Although not shown, the Wi-Fi device 10 also has a power supply, which may be a battery or a connection to a permanent power source, such as a wall outlet.

While the processing unit 20, the memory device 25, the Wi-Fi network interface 30, the data memory device 40 and the timer 50 are shown in FIG. 1 as separate components, it is understood that some or all of these components may be integrated into a single electronic component. Rather, FIG. 1 is used to illustrate the functionality of the Wi-Fi device 10, not its physical configuration.

In the wake state, all of the components described above may be powered. In the low power mode, also referred to as power saving or sleep mode, one or more of these components may be in a sleep mode or powered off.

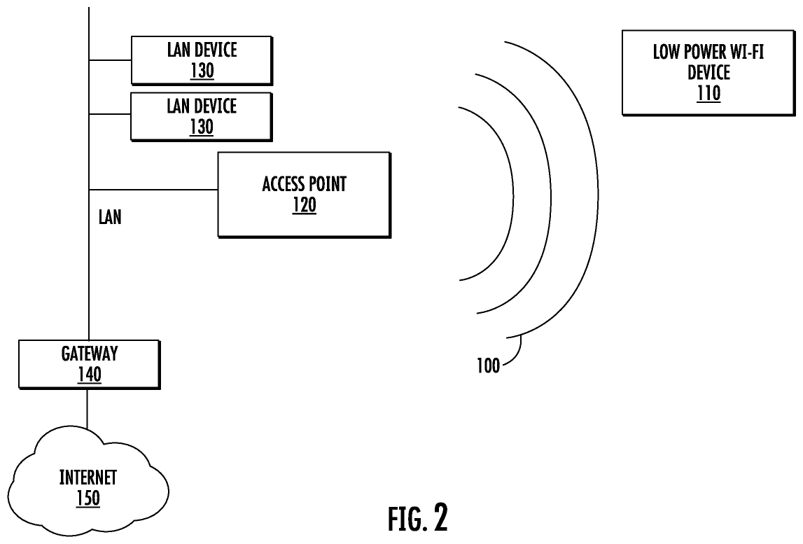

FIG. 2 shows a system that includes a Wi-Fi network 100. The Wi-Fi network 100 includes a low power Wi-Fi device 110 and access point 120, both of which may have an architecture similar to that shown in FIG. 1. In other words, both low power Wi-Fi device 110 and access point 120 are Wi-Fi network devices. The low power Wi-Fi device 110 may have a battery as a power source and may include a lower power processing unit and less memory capacity than the access point 120.

The access point 120 may also be in communication with a local area network (LAN). This LAN may be an Ethernet network, although other types of networks may be used. Also disposed on the LAN may be one or more LAN devices 130. These LAN devices 130 may include printers, personal computers, servers, and other devices. Additionally, a gateway 140 may be in communication with the LAN, and allow access to the internet 150.

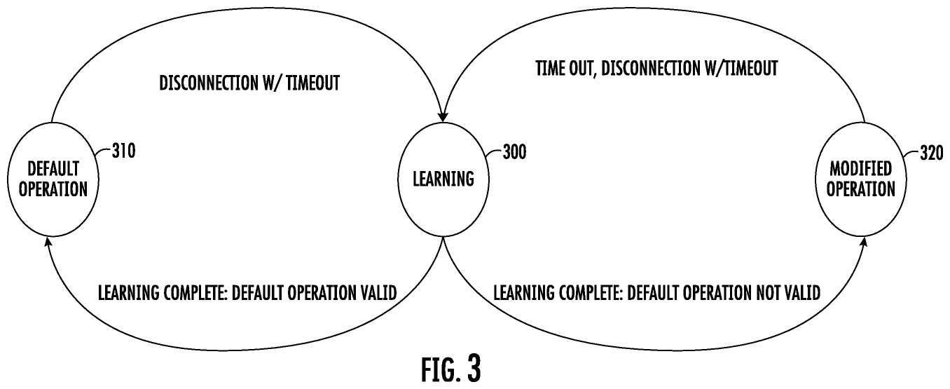

FIG. 3 shows a general flowchart showing the operation of the low power Wi-Fi device. First, the low power Wi-Fi device 110 is initialized to a learning state 300. While in this learning state 300, the low power Wi-Fi device 110 observes the behavior of the access point 120. These observations may include detecting the number and/or types of packets sent by the access point 120 or by detecting the response of the access point 120 to a packet sent by the low power Wi-Fi device 110. While in this learning state 300, the low power Wi-Fi device is operating using its default mode of operation. After observing the behavior of the access point 120, the low power Wi-Fi device 110 determines whether the behavior of the access point 120 is as expected or is different than expected. If the behavior of the access point is as expected, no changes are made to the operation of the low power Wi-Fi device 110 and it enters the default operation state 310. If, however, the observed behavior differs from that expected, the low power Wi-Fi device 110 modifies its operation, and enters a modified operation state 320. This modification to its operation may enable the low power Wi-Fi device 110 to reduce its power consumption. Once the low power Wi-Fi device 110 has completed its learning, it remains in the selected state (either default operation state 310 or modified operation state 320) until the connection with the access point 120 is terminated. Further, in some embodiments, when operating in the modified operation state 320, the low power Wi-Fi device 110 may return to the learning state 300 at regular intervals to determine whether the operation of the access point 120 has changed.

This approach may be used to observe many different possible behaviors.

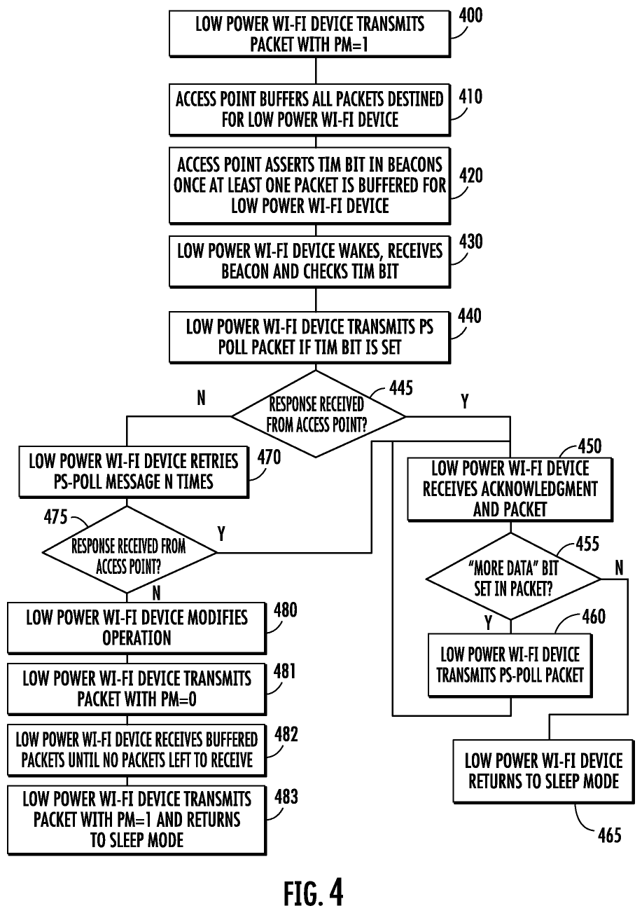

FIG. 4 shows a first behavior that may be monitored. One area in which the behavior of access points 120 differ is their response to PS-Poll packets. When a low power Wi-Fi device 110 enters power saving mode, it transmits a packet with the PM (power management) bit set to one, as shown in Box 400. This may be a NULL packet, a QOS (Quality of Service) NULL packet, a data packet or a QOS data packet. In response, the access point 120 will now buffer any packets destined for the low power Wi-Fi device 110, as shown in Box 410. Once there are any buffered packets for this low power Wi-Fi device in the access point 120, it will assert the TIM bit for the low power Wi-Fi device 110 in its beacons, as shown in Box 420. When the low power Wi-Fi device 110 exits power saving or sleep mode, it checks the TIM bit in the beacon, as shown in Box 430. If the TIM bit corresponding to this Wi-Fi device is set to one, the low power Wi-Fi device 110 attempts to retrieve the packet (or packets) from the access point 120 by transmitting a PS-Poll packet to the access point 120, as shown in Box 440. The low power Wi-Fi device 110 then waits for a response, as shown in Decision Box 445. In response, the access point 120 may transmit an acknowledgment followed by the first of the buffered packets to the low power Wi-Fi device 110. In this case, the low power Wi-Fi device receives the acknowledgment and packet, as shown in Box 450. This is referred to as the expected behavior. If that packet has the “more data” bit set, the low power Wi-Fi device 110 will transmit another PS-Poll packet, as shown in Decision Box 455 and Box 460. This behavior repeats until the “more data” bit is no longer set, at which point the low power Wi-Fi device 110 returns to power saving or sleep mode, as shown in Box 465. However, certain access points may not respond to the PS-Poll packets. This is referred to as unexpected behavior. In response, the low power Wi-Fi device 110 may retransmit the PS-Poll packet one or more additional times, in case the earlier packets simply wasn't received by the access point 120. This is shown in Box 470. Then, the low power Wi-Fi device 110 checks for a response, as shown in Decision Box 475. If the access point 120 responds to one of these retransmissions, the low power Wi-Fi device 110 assumes that this is expected behavior and receives the packet, as shown in Box 450 and continues using the default mode of operation as described above. If, however, the access point 120 does not respond, the low power Wi-Fi device modifies its operation, as shown in Box 480. This modified operation may comprise the following sequence. First, the low power Wi-Fi device 110 transmits a packet with the power management (PM) bit set to 0, indicating that it is in active mode, as shown in Box 481. Note that this packet may be a NULL packet, a QOS NULL packet, a data packet or a QOS data packet. It then receives all of the buffered packets, as shown in Box 482. Once it infers that all the buffered packets have been received, the low power Wi-Fi device 110 transmits a packet with PM=1 and returns to power saving or sleep mode, as shown in Box 483.

Note that, in one embodiment, once the low power Wi-Fi device 110 modifies its operation, that modification may stay in effect as long as the low power Wi-Fi device 110 is connected to the access point 120. Thus, looking at FIG. 4, if the low power Wi-Fi device 110 has modified its behavior, the next time it exits power saving or sleep mode, it executes Box 430 and if the TIM bit is set, the low power Wi-Fi device 110 proceeds directly to Box 481. In this way, the low power Wi-Fi device 110 does not consume power transmitting and then retransmitting PS-Poll packets to the access point 120. Thus, Boxes 480-483 constitute the modified operation state 320, as described with respect to FIG. 3.

In another embodiment, as explained with respect to FIG. 3, the low power Wi-Fi device 110 may only modify its behavior for a predetermined amount of time. In this embodiment, the low power Wi-Fi device tracks the duration of time that it has been in the modified operation state 320. Once that duration reaches a predetermined threshold, the low power Wi-Fi device 110 returns to the learning state 300 by attempting to determine if the access point 120 can process PS-Poll messages by executing Boxes 430 and 440.

Rather than using time, the low power Wi-Fi device 110 may track the number of buffered packets that it has retrieved from the access point 120 while using modified operation. The low power Wi-Fi device 110 may re-enter the learning state 300 after a predetermined number of buffered packets have been retrieved.

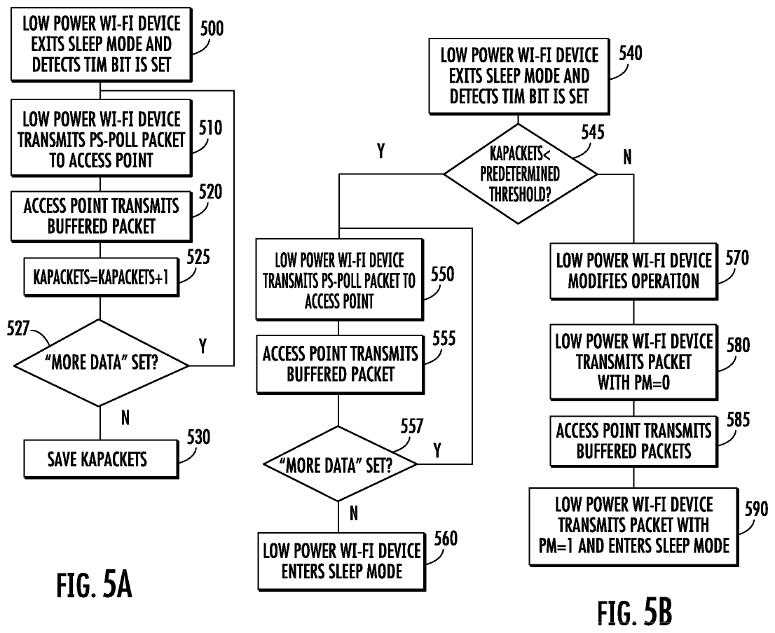

FIGS. 5A-5B show another example of modified operation based on the behavior of the access point 120. This example pertains to the behavior of the access point 120 regarding “keep alive” messages. The access point 120 may periodically send “keep alive” messages. These may be NULL packets or QOS NULL packets. The access point 120 may transmit bursts of “keep alive” messages, wherein the burst may include 1, 2 or 3 packets. Based on this value, the low power Wi-Fi device 110 determines how to operate when awakening from sleep mode. FIG. 5A shows the learning or characterization process. First, as noted in Box 500, the low power Wi-Fi device 110 exits power saving or sleep mode and detects that the TIM bit is set. In response, it sends a PS-Poll packet to the access point 120, as shown in Box 510. The access point 120 then responds by transmitting the first “keep alive” message, as shown in Box 520. The low power Wi-Fi device 110 increments the number of “keep alive” messages that have been transmitted since it exited sleep mode, as shown in Box 525. If the “more data” bit is set (as shown in Decision Box 527), the low power Wi-Fi device 110 transmits another PS-Poll packet (see Box 510). This sequence repeats until the “more data” flag is no longer set. The low power Wi-Fi device 110 then records the number of “keep alive” messages (KAPackets) that were buffered, as shown in Box 530. This value helps the low power Wi-Fi device 110 to determine the mode of operation going forward. This completes the process to characterize the behavior of the access point 120. Thus, this constitutes the actions performed in the learning state 300.

FIG. 5B shows the sequence that may be used by the low power Wi-Fi device after this learning or characterization process is performed. As shown in Box 540, the low power Wi-Fi device 110 exits power saving or sleep mode and detects that the TIM bit is set. In response, it checks to see the number of “keep alive” packets that are typically sent by this access point 120, as determined during the learning or characterization process. Based on this value, the low power Wi-Fi device 110 may modify its operation, as shown in Decision Box 545. For example, if the number of “keep alive” messages is typically less than a certain threshold, which may be 2, as an example, the low power Wi-Fi device 110 may remain in its default operation state 310. In this default operation state, the low power Wi-Fi device 110 transmits a PS-Poll packet to the access point 120, as shown in Box 550. In response, the access point 120 transmits a buffered packet, as shown in Box 555. This sequence is repeated until the “more data” bit is no longer set, as shown in Decision Box 557. After this, the low power Wi-Fi device 110 returns to power saving or sleep mode, as shown in Box 560.

If, however, the typical number of “keep alive messages” is not less than the predetermined threshold, the low power Wi-Fi device 110 may modify its operation, as shown in Box 570. In this modified operation state 320, the low power Wi-Fi device may transmit a packet with PM=0 to the access point 120, indicating that it is active, as shown in Box 580. This may be a NULL packet, a QOS NULL packet, a data packet or a QOS data packet. In response, the access point 120 will begin transmitting the buffered packets, without the need for the low power Wi-Fi device 110 to transmit multiple PS-Poll packets, as shown in Box 585. Once the last packet has been received by the low power Wi-Fi device 110, the low power Wi-Fi device 110 transmits a packet with PM=1, as shown in Box 590, and returns to power saving or sleep mode.

Thus, when the low power Wi-Fi device determines that the behavior of the access point 120 is such that multiple packets will have been buffered when the low power Wi-Fi device 110 exits sleep mode, it may modify its operation to exit legacy power management mode, so that it does not have to transmit multiple PS-Poll packets. Further, this approach may also serve to reduce the total time that the low power Wi-Fi device 110 is not in sleep mode. Note that this is the same modified behavior as occurs when the low power Wi-Fi device 110 determines that the access point 120 does not respond to PS-Poll packets.

A third example of modified operation based on the behavior of the access point 120 pertains to aggregation. Aggregation is a feature by which two or more data frames are sent as one transmission. This feature reduces overhead as multiple packets share a common PHY header, the number of accesses to the medium are reduced (one access for these frames), wait time for acknowledgments and the number of acknowledgments are reduced. To establish aggregation, the access point and the low power Wi-Fi device must negotiate various parameters, such as maximum number of data frames in one transmission. These parameters are collectively referred to as the aggregation context.

Unfortunately, certain access points may delete the aggregation context when the low power Wi-Fi device goes to power saving or sleep mode. Then, when the access point 120 has data to transmit to the low power Wi-Fi device 110, it sets the TIM bit.

Subsequently upon reception of the PS-Poll packet, the access point may then attempt to establish the aggregation context. This leads to multiple transmissions and receptions of frames before the actual data frame is transmitted. When the low power Wi-Fi device expects a small amount of data being sent to it after a long time interval, referred to as occasional data (e.g. for a door lock), these established aggregation context get destroyed and re-established next time. These additional transmissions and receptions cause battery drain.

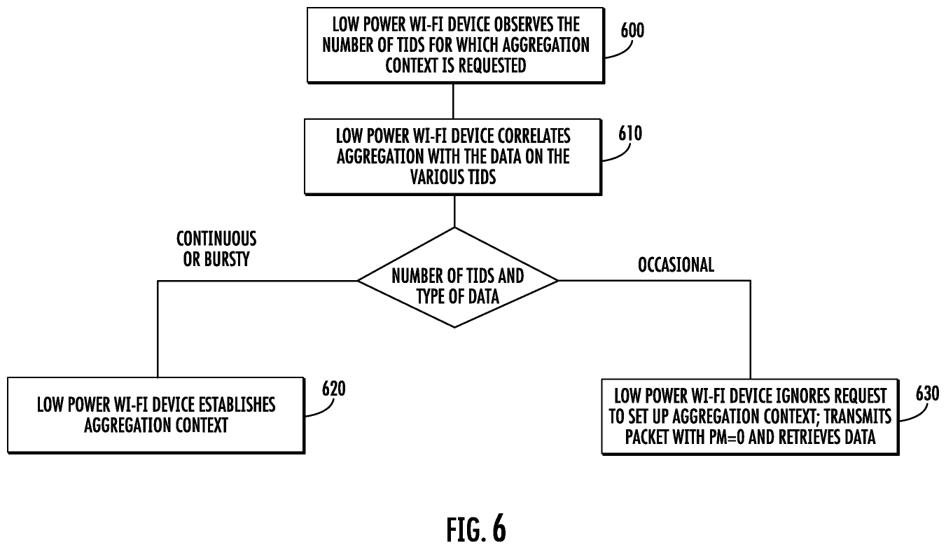

Thus, the low power Wi-Fi device 110 may modify its operation based on the aggregation context requested by the access point 120. FIG. 6 shows this procedure. First, as shown in Box 600, the low power Wi-Fi device 110 may observe the number of TIDs (traffic identifiers) for which aggregation context is requested by the access point 120. The low power Wi-Fi device 110 will also correlate the aggregation with the type of data on the various TIDS, as shown in Box 610.

Based on this information, the low power Wi-Fi device 110 may take different actions. As shown in Box 620, if the aggregation context TID is set up only for a TID on which the low power Wi-Fi device 110 has continuous or bursty data, the low power Wi-Fi device 110 may enter the default operation state 310 and establish the aggregation context. If, however, the aggregation context is set up for the TID on which the low power Wi-Fi device 110 has occasional data as well as other TIDs, the low power Wi-Fi device 110 may enter the modified operation state 320 and ignore or reject the requests to set up an aggregation context and send a packet with PM=0 to the access point 120, as shown in Box 630. This packet may be a NULL packet, a QOS NULL packet, a data packet or a QOS data packet. This will allow the low power Wi-Fi device 110 to retrieve the data but will not establish any aggregation context, thereby reducing transmissions.

Note that, as shown in FIG. 3, the observations and modification made by the low power Wi-Fi device may be deleted if the low power Wi-Fi device 110 becomes disconnected from the access point. This disconnect may happen for a variety of reasons. For example, the low power Wi-Fi device may leave the basic service set (BSS) of the access point 120. Alternatively, the access point 120 may have gone off-line, such as to receive a software update.

In the first scenario, the observations made by the low power Wi-Fi device about the access point 120 are still valid. Thus, in certain embodiments, the low power Wi-Fi device 110 may save the last timestamp that it received from the access point 120. This may be contained within the TSF field of the beacon. The low power Wi-Fi device may then calculate the time that it was outside the BSS of the access point 120, referred to as “away time”. When it returns to the BSS of the access point 120, it calculates an expected timestamp, by adding the last received timestamp and the away time. If the TSF field received in the next beacon from the access point is within the expected range, the low power Wi-Fi device may save all of its previously learned information about this access point 120. However, if the TSF field received in the next beacon is outside the expected range, the low power Wi-Fi device 110 may forget its learned behavior and return to the learning state 300 and restart the characterization.

This system and method has many advantages. By tracking the behavior of the access point, the low power Wi-Fi device may reduce its power consumption in several ways. First, it may reduce the number of packets that are transmitted and not acted upon. Second, it may reduce the number of PS-Poll packets in scenarios where a large number of buffered packets are expected. Third, it may reduce transmissions by limiting aggregation in certain cases.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of operating a low power Wi-Fi device, comprising:
observing a behavior of an access point while the low power Wi-Fi device is in a default operation state; and
if the behavior differs from an expected behavior, modifying an operation of the low power Wi-Fi device to reduce transmissions or power consumption.

2. The method of claim 1, wherein the low power Wi-Fi device observes a response of the access point to PS-Poll messages.

3. The method of claim 2, wherein if the access point does not respond to PS-Poll messages, the low power Wi-Fi device modifies the operation by transmitting packets with a power management (PM) bit set to 0 or 1 to indicate when the low power Wi-Fi device is in an active mode and a power saving mode, respectively.

4. The method of claim 3, wherein the packets transmitted with the PM bit set to 0 or 1 are NULL packets, QOS NULL Packets, data packets or QOS data packets.

5. The method of claim 1, wherein the low power Wi-Fi device observes a number of “keep alive” messages transmitted by the access point while the low power Wi-Fi device is in a power saving or sleep mode.

6. The method of claim 5, wherein if the number of “keep alive” messages is less than a predetermined threshold, the low power Wi-Fi device utilizes PS-Poll messages.

7. The method of claim 5, wherein if the number of “keep alive” messages is greater than a predetermined threshold, the low power Wi-Fi device modifies the operation by transmitting packets with a power management (PM) bit set to 0 to indicate that the low power Wi-Fi device is in an active mode.

8. The method of claim 1, wherein the low power Wi-Fi device observes a number and type of TIDs (traffic identifiers) for which aggregation context is requested by the access point.

9. The method of claim 8, wherein if the low power Wi-Fi device has continuous or bursty data associated with the TIDs, it establishes the aggregation context.

10. The method of claim 8, wherein if the low power Wi-Fi device has occasional data associated with the TIDs, the low power Wi-Fi device modifies the operation by rejecting the request and transmitting packets with a power management (PM) bit set to 0 to indicate that the low power Wi-Fi device is in an active mode.

11. The method of claim 1, further comprising exiting a modified operation mode after a predetermined amount of time or a predetermined number of packets, and repeating the observing.

12. The method of claim 1, further comprising exiting a modified operation mode if a connection between the low power Wi-Fi device and the access point is terminated and repeating the observing.

13. A low power Wi-Fi device, comprising:
a Wi-Fi network interface;
a processing unit; and
a memory device, in communication with the processing unit, containing instructions, which when executed by the processing unit, enable the low power Wi-Fi device to:
observe a behavior of an access point while the low power Wi-Fi device is in a default operation state; and
modify an operation of the low power Wi-Fi device if the behavior differs from an expected behavior, in order to reduce transmissions or power consumption.

14. The low power Wi-Fi device of claim 13, wherein the low power Wi-Fi device observes a response of the access point to PS-Poll messages.

15. The low power Wi-Fi device of claim 14, wherein the memory device further comprising instructions that enable the low power Wi-Fi device to:
modify the operation by transmitting packets with a power management (PM) bit set to 0 or 1 to indicate when the low power Wi-Fi device is in an active mode and a power saving mode, respectively, if the access point does not respond to PS-Poll messages.

16. The low power Wi-Fi device of claim 13, wherein the low power Wi-Fi device observes a number of “keep alive” messages transmitted by the access point while the low power Wi-Fi device is in a power saving or sleep mode.

17. The low power Wi-Fi device of claim 16, wherein the memory device further comprising instructions that enable the low power Wi-Fi device to:
transmit PS-Poll messages if the number of “keep alive” messages is less than a predetermined threshold; and
transmit packets with a power management (PM) bit set to 0 to indicate that the low power Wi-Fi device is in an active mode if the number of “keep alive” messages is equal to or greater than the predetermined threshold.

18. The low power Wi-Fi device of claim 13, wherein the low power Wi-Fi device observes a number and type of TIDS (traffic identifiers) for which aggregation context is requested by the access point.

19. The low power Wi-Fi device of claim 18, wherein the memory device further comprising instructions that enable the low power Wi-Fi device to:
establish the aggregation context if the low power Wi-Fi device has continuous or bursty data associated with the TIDs; and
reject request and transmit packets with a power management (PM) bit set to 0 to indicate that the low power Wi-Fi device is in an active mode if the low power Wi-Fi device has occasional data associated with the TIDS.
